(19) United States
(12) Patent Application Publication
(10) Pub. No.: US 2006/0103127 A1
(43) Pub. Date: May 18, 2006

(54) Module structure for a vehicle

(75) Inventors: Tjong T. Lie, Naperville, IL (US); Garrick Hu, West Bloomfield, MI (US)

Correspondence Address: CARLSON, GASKEY & OLDS, P.C., 400 WEST MAPLE ROAD, SUITE 350, BIRMINGHAM, MI, 48009, US

(73) Assignee: Arvin Technology, LLC

(21) Appl. No.: 10/990,034

(22) Filed: Nov. 16, 2004

(51) Int. Cl. B62D 21/00

(52) U.S. Cl. 280/781

(57) ABSTRACT

A vehicle includes two frame beams, such as c-channels, and a module structure attached to the frame beams to define a vehicle frame. An independent front suspension is attached to the module structure. A radiator, an engine and an energy absorbing front bumper are attached to mounting brackets of the module structure. When the module structure is attached to the frame beams, the engine is located under seats in the cab and behind the independent front suspension. A hood of the vehicle can be inclined relative to the ground, improving the aerodynamic shape of the cab and driver visibility.

### TECHNICAL FIELD

This invention relates generally to a module structure that is attachable to a pair of frame beams to define a vehicle frame, and more specifically relates to a module structure that includes an independent front suspension and mounting brackets for an engine, a radiator, a cab and an energy absorbing front bumper.

### BACKGROUND OF THE INVENTION

Trucks generally have a ladder-type frame structure including two parallel c-channels that extend the length of the truck and several perpendicular cross-members connecting the c-channels. An independent front suspension is directly attached to the c-channels. The independent front suspension includes a stabilizer bar and control arms attached to each end of the stabilizer bar. A steering knuckle attached to each control arm includes a wheel spindle, and a wheel is attachable to each wheel spindle. Major reinforcements are usually required to allow the independent front suspension to be mounted to the c-channels, adding additional weight to the truck.

An engine is mounted between the c-channels generally above the independent front suspension and in a front portion of a cab of the truck. A radiator is typically mounted on a front cross-member in front of the engine, and the radiator is generally perpendicular to the ground. A drawback to this configuration is that it is difficult to attach the independent front suspension to the c-channels due to the presence of the engine between the control arms.

A hood generally encloses the engine and the radiator over the ladder-type frame structure. When the engine is located over the independent front suspension, the hood is generally parallel to the ground and has a relatively high height to provide space for the engine. When viewed from the side, the front of the truck has a generally rectangular shape. A drawback to this configuration is that the hood can negatively affect the aerodynamic shape of the cab and potentially reduce driver visibility.

In another known truck configuration, the engine is located in a back portion of the cab. The cab is therefore shorter, decreasing the overall length of the truck and improving maneuverability. However, when the engine is located in the back portion of the cab, driver and passenger seats are generally located above the independent front suspension and the engine, raising the height of the seats and increasing the possibility of swaying and pitching, which can result in an uncomfortable ride.

Hence, there is a need for a module structure including a front independent suspension and mounting brackets for an engine, a radiator, a cab and an energy absorbing front bumper that overcomes the drawbacks and the shortcomings of the prior art.

### SUMMARY OF THE INVENTION

The present invention provides a module structure that is attachable to frame beams of a truck to define a vehicle frame. The module structure includes an independent front suspension and mounting brackets for an engine, a radiator, a cab and an energy-absorbing front bumper.

A vehicle, such as a truck, includes a cab having driver and passenger seats and a sleeping section behind the driver and passenger seats. In one embodiment, the frame beams are c-channels, and the module structure is attached to the frame beams to define a vehicle frame. The module structure includes at least four beams, a plurality of cross-beams, and a plurality of struts that define a cage-like structure.

The module structure includes engine mounting brackets for an engine. The engine mounting brackets are located near a rear end of the module structure and behind the independent front suspension. The engine is attached to the engine mounting brackets and mounted near the rear end of the module structure.

The module structure further includes radiator mounting brackets for a radiator. The radiator mounting brackets are located near a front end of the module structure. When the radiator is attached to the radiator mounting brackets, the radiator is inclined and located near the front end of the module structure.

The module structure also includes bumper brackets located near the front end of the module structure for an energy-absorbing front bumper. The energy absorbing front bumper is attached to the bumper brackets to protect the module structure in the possible event of front impacts.

The independent front suspension is attached to suspension mounting brackets located between the engine mounting brackets and the radiator mounting brackets. After attaching the independent front suspension, the engine, the radiator, and the energy absorbing front bumper to the module structure, the rear end of the module structure is attached to a front end of the frame beams with fasteners. When the module structure is attached to the frame beams, the engine is approximately located below the driver and passenger seats of the cab. Because the engine is not located in front of the cab, a hood of the vehicle can be inclined relative to the ground, increasing driver visibility and improving the aerodynamic shape of the vehicle. The radiator is also inclined relative to the ground and is substantially parallel to the hood.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates a side view of a prior art vehicle including frame beams that define a vehicle frame;

FIG. 2 schematically illustrates a side view of a vehicle including the module structure of the present invention;

FIG. 3 illustrates a perspective view of the module structure of the present invention;

FIG. 4 illustrates a perspective view of an independent front suspension; and

FIG. 5 illustrates a perspective view of a portion of the module structure including the suspension mounting brackets for the independent front suspension.

### DETAILED DESCRIPTION OF THE PREFERRED EMBODIMENT

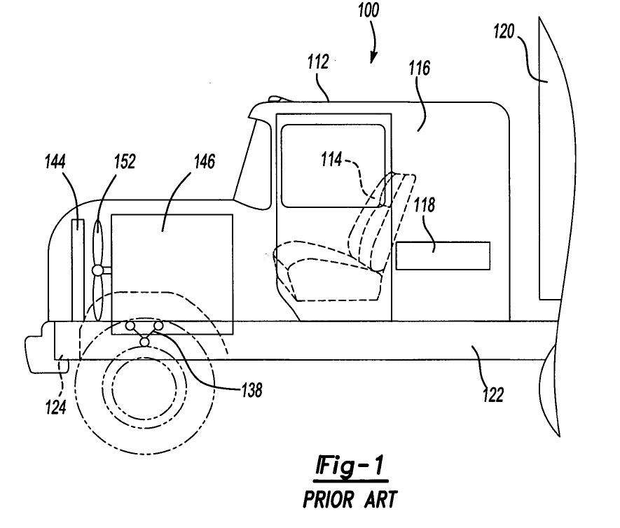

FIG. 1 schematically illustrates a side view of a prior art vehicle 100 including a cab 112 having a driver's seat 114 and a sleeping section 116 with a bed 118. The vehicle 100 hauls a trailer 120. Two c-channels 122 extend the entire length of the vehicle 100, support the cab 112 and define a vehicle frame. An engine 146 is mounted between the c-channels 122 generally above an independent front suspension 138. A radiator 144 is typically mounted in front of the engine 146 on a cross member 124 extending between the c-channels 122, and the radiator 144 is generally perpendicular to the ground. A fan 152 draws air over the radiator 144. The front of the vehicle 100 has a generally rectangular shape.

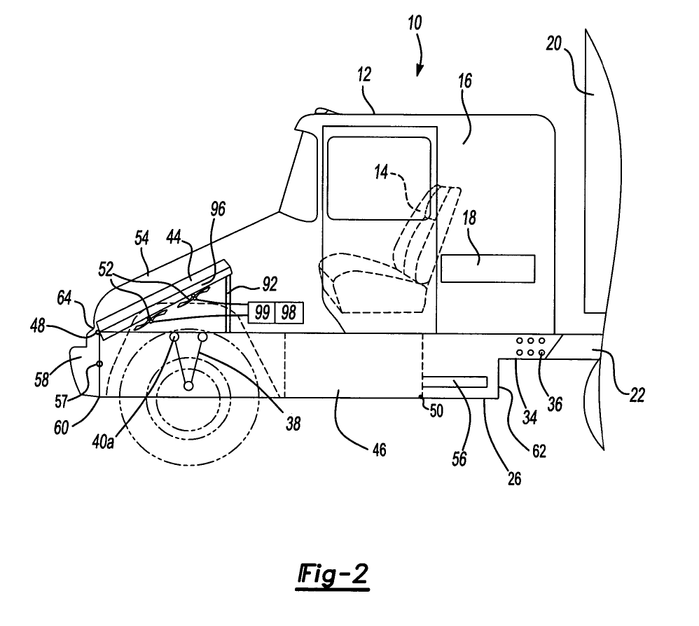

FIG. 2 schematically illustrates a side view of a vehicle 10 of the present invention, such as a truck. The vehicle 10 includes a cab 12 having a driver's seat 14, a passenger's seat (not shown), and a sleeping section 16 behind the driver's seat 14 with a bed 18. The vehicle 10 hauls a trailer 20.

Two frame beams 22 extend partially along the length of the vehicle 10. Preferably, the frame beams 22 are c-channels. Although c-channels are illustrated and described, it is to be understood that the frame beams 22 can have other shapes. For example, the frame beams 22 can be substantially I-shaped. Preferably, the frame beams 22 are substantially parallel to each other. However, the frame beams 22 can also be non-parallel to each other.

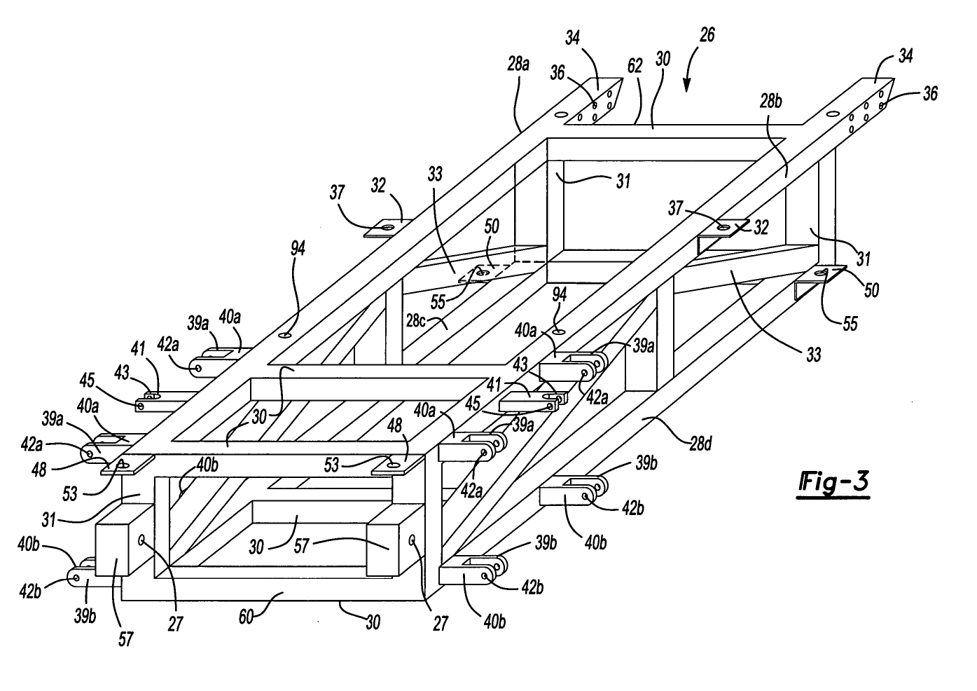

A module structure 26 is attached to the frame beams 22 to define a vehicle frame that supports the cab 12. As shown in FIG. 3, the module structure 26 includes a cage-like structure that is formed of four beams 28a, 28b, 28c and 28d. Preferably, the beams 28a, 28b, 28c and 28d are parallel. A plurality of cross-beams 30 extend transversely to the four beams 28a, 28b, 28c and 28d. The plurality of cross-beams 30 are preferably perpendicular to the four beams 28a, 28b, 28c and 28d and are preferably parallel to the ground. A plurality of cross-beams 31 extend transversely to the four beams 28a, 28b, 28c and 28d. Preferably, the plurality of cross-beams 31 are perpendicular to the four beams 28a, 28b, 28c and 28d and are preferably perpendicular to the ground.

The four beams 28a, 28b, 28c and 28d, the plurality of cross-beams 30 and 31, and a plurality of struts 33 form a cage-like structure that defines the module structure 26. The module structure 26 extends from a front end 60 to a rear end 62. Preferably, the front end 60 of the module structure 26 has substantially the same width as the rear end 62 of the module structure 26. Also, while the module structure 26 is shown as an integral part, it should be understood that the four beams 28a, 28b, 28c and 28d, the plurality of cross-beams 30 and 31, and the plurality of struts 33 would typically be separate parts welded together.

If the frame beams 22 are non-parallel, the beams 28a and 28c may be non-parallel or angled with respect to the beams 28b and 28d. For example, the beams 28a, 28b, 28c and 28d can be oriented such that the front end 60 of the module structure 26 is narrower than the rear end 62. Alternately, the front end 60 of the module structure 26 can be wider than the rear end 62. The beams 28a, 28b, 28c and 28d are oriented such that the rear end 62 has a width that enables the module structure 26 to be attached to the frame beams 22. The beams 28a and 28c may also be non-parallel or angled with respect to the beams 28b and 28d even if the frame beams 22 are parallel. Alternately, the beams 28a, 28b, 28c and 28d can be parallel and the frame beams 22 can be non-parallel.

The module structure 26 includes four upper mounting brackets 40a, each having two arms 39a with each arm 39a having an aperture 42a. The module structure 26 also includes four lower mounting brackets 40b, each having two arms 39b with each arm 39b having an aperture 42b. Two of the upper mounting brackets 40a are located on each of the beams 28a and 28b, and two of the lower mounting brackets 40b are located on each of the beams 28c and 28d. The upper mounting brackets 40a and the lower mounting brackets 40b are located between the front end 60 and the rear end 62 of the module structure 26.

An air spring bracket 41 is located on each of the beams 28a and 28b between the two upper mounting brackets 40a. Each air spring bracket 41 includes two arms 43 each having an aperture 45.

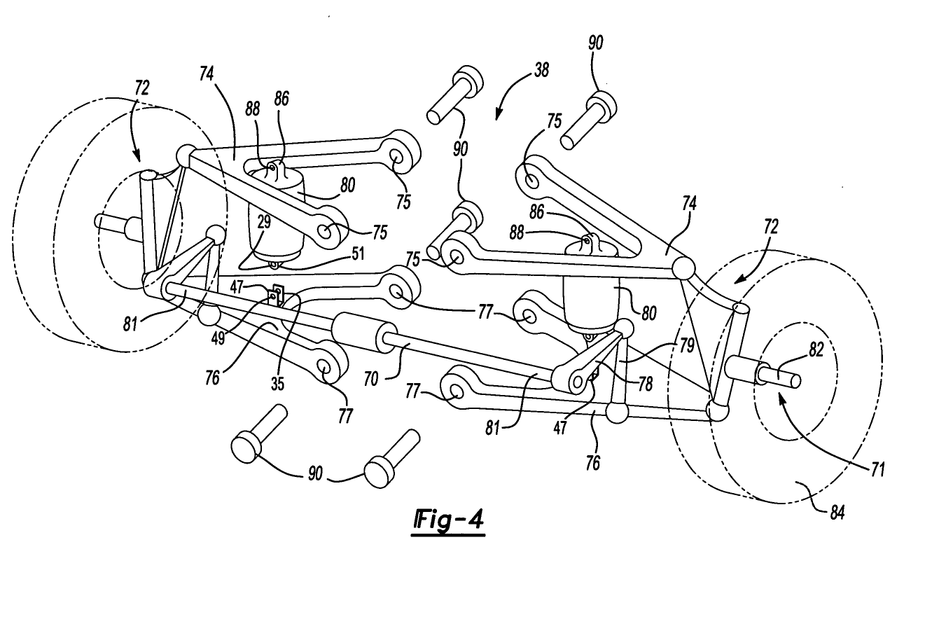

An independent front suspension 38 is attached to the upper mounting brackets 40a and the lower mounting brackets 40b, as explained below. As shown in FIG. 4, the independent front suspension 38 includes a stabilizer bar 70 (also known as an anti-roll bar or an anti-sway bar) and two control arm assemblies 72. As known, the stabilizer bar 70 provides a stabilizer function. The control arm assemblies 72 each include an upper control arm 74 and a lower control arm 76. Each control arm assembly 72 also includes a knuckle assembly 71 having a wheel spindle 82. A wheel 84 is supported on each wheel spindle 82. A link 78 attaches each of the ends 81 of the stabilizer bar 70 to one of the lower control arms 76 via a drop link 79.

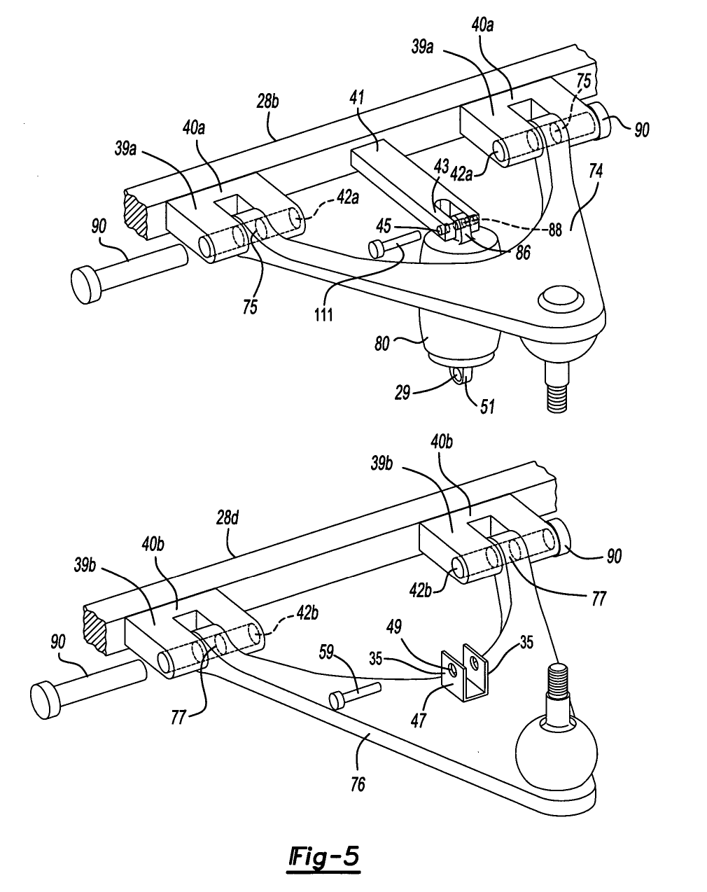

As shown in FIG. 5, each upper control arm 74 includes two apertures 75, and each lower control arm 76 includes two apertures 77. Each control arm assembly 72 also includes an air spring/shock absorber 80 that absorbs shocks. Each air spring/shock absorber 80 includes a first mounting 86 having an aperture 88 and second mounting 51 having an aperture 29. When the independent front suspension 38 is attached to the module structure 26, each air spring/shock absorber 80 is located between one of the beams 28a and 28b of the module structure 26 and one of the lower control arms 76. Each lower control arm 76 also includes a unshaped mounting bracket 47 including two arms 35 each having an aperture 49.

As the independent front suspension 38 is attached to the module structure 26, each aperture 75 of the upper control arms 74 is aligned with the apertures 42a in the arms 39a of one of the upper mounting brackets 40a, and each aperture 77 of the lower control arms 76 is aligned with the apertures 42b in the arms 39b of one of the lower mounting brackets 40b. A fastener 90 is received in the aligned apertures 75 and 42a and the aligned apertures 77 and 42b to attach the independent front suspension 38 to the module structure 26.

The aperture 88 in the first mounting 86 of the air spring/shock absorber 80 is also aligned with the apertures 45 in the arms 43 of the air spring bracket 41. A fastener 111 passes through the aligned apertures 45 and 88 to secure the air spring/shock absorber 80 to the module structure 26. The aperture 29 of the second mounting 51 is also aligned with the apertures 49 in the arms 35 of the mounting bracket 47 of the lower control arm 76. A fastener 59 passes through the aligned apertures 49 and 29 to secure the air spring/shock absorber 80 to the lower control arm 76. When attached, the independent front suspension 38 is located between the front end 60 and the rear end 62 of the module structure 26. Although the beams 28a and 28c are not illustrated and described, it is to be understood that the other upper control arm 74 and lower control arm 76 of the independent front suspension 38 are attached to the two upper mounting brackets 40a of the beam 28a and the two lower mounting brackets 40b of the beam 28c, respectively, in the same manner.

Returning to FIG. 3, the module structure 26 further includes two radiator mounting brackets 48 located near the front end 60 of the module structure 26. A radiator 44 (shown in FIG. 2) is attached to the two radiator mounting brackets 48 near the front end 60 of the module structure 26. The two radiator mounting brackets 48 each include an aperture 53. A fastener (not shown) is received in each aperture 53 of the two radiator mounting brackets 48 to attach the radiator 44 to the module structure 26.

The module structure 26 further includes two engine mounting brackets 50 (shown schematically) located on the beams 28c and 28d near the rear end 62 of the module structure 26. That is, the two engine mounting brackets 50 are each located in the lower rear portion of the module structure 26. An engine 46 (shown in FIG. 2) is attached to the two engine mounting brackets 50. The two engine mounting brackets 50 each include an aperture 55. A fastener (not shown) is received in each aperture 55 of the two engine mounting brackets 50 to attach the engine 46 to the module structure 26.

The module structure 26 further includes cab mounting brackets 32 (shown schematically) located between the front end 60 and the rear end 62 of the module structure 26. The cab 12 (shown in FIG. 2) is attached to the cab mounting brackets 32. The cab mounting brackets 32 each includes an aperture 37. A fastener (not shown) is received in each aperture 37 of the cab mounting brackets 32 to attached the cab 12 to the module structure 26.

The module structure 26 further includes two bumper brackets 57 each attached to one of the cross-beams 31 near the front end 60 of the module structure 26. An energy-absorbing front bumper 58 is attached to the two bumper brackets 57 to reduce the effect of possible vehicle impacts. Each of the two energy absorbing front bumper brackets 57 include an aperture 27. A fastener (not shown) is received in each of the apertures 27 of the two energy absorbing front bumper brackets 57 to attach the energy-absorbing front bumper 58 to the module structure 26.

The rear end 62 of the module structure 26 is attached to an inner surface of a front end of the frame beams 22 with fasteners (not shown). The frame beams 22 include a plurality of apertures (not shown). Two extensions 34 near the rear end 62 of the module structure 26 each include a plurality of apertures 36. One extension 34 extends from the beam 28a, and the other extension 34 extends from the beam 28b. Preferably, each of the two extensions 34 includes six apertures 36, although it is to be understood that any number of apertures 36 can be employed. The number of apertures in each frame beam 22 is equal to the number of apertures 36 in each of the two extensions 34.

When the module structure 26 is attached to the frame beams 22, the module structure 26 is positioned relative to the frame beams 22 such that each of the plurality of apertures 36 in each of the two extension 34 in the module structure 26 substantially align with one of the plurality of apertures in the frame beams 22. The fasteners pass through the aligned apertures 36 to attach the rear end 62 of the module structure 26 to the front end of the frame beams 22. The independent front suspension 38 also supports the module structure 26. When attached to the frame beams 22, the module structure 26 forms part of the vehicle frame. When the module structure 26 is attached to the frame beams 22, the four beams 28a, 28b, 28c, and 28d of the module structure 26 extend substantially parallel to the frame beams 22.

In prior vehicles, the engine is located in the front area of the cab of the vehicle. The engine is located under a hood, and the cab has a generally rectangular appearance when viewed from the side. The hood of the prior vehicles is substantially parallel to the ground.

Returning to FIG. 2, when the module structure 26 of the present invention is attached to the frame beams 22, the engine 46 is located generally below the driver's seat 14 in the cab 12. The engine 46 is not located toward the front of the cab 12, and therefore a hood 54 of the vehicle 10 can be sloped or inclined relative to the ground. That is, the hood 54 of the vehicle 10 is not substantially parallel to the ground, but is angled or inclined relative to the ground. When the vehicle 10 is viewed from the side, the hood 54 provides a generally triangular appearance. The hood 54 is attached to the vehicle 10 at a pivot 64. When the module structure 26 is attached to the vehicle 10, the front end 60 of the module structure 26 is attached to the hood 54 near the pivot 64.

By locating the engine 46 below the driver's seat 14 in the cab 12, the engine 46 and the center of gravity of the engine 46 is lowered as compared to prior vehicles, increasing stability of the vehicle 10 and reducing swaying of the vehicle 10. The roll-over resistance of the vehicle 10 also increases, improving handling.

When the vehicle 10 is operating, the engine 46 generates heat. A liquid coolant flows through the engine 46, and heat from the engine 46 is transferred to the liquid coolant. The liquid coolant flows into the radiator 44 which then transfers the heat to the surrounding air. Two remotely driven fans 52 draw air over the radiator 44 to facilitate the exchange of heat between the liquid coolant and the air.

The radiator 44 is inclined relative to the ground and is generally parallel to the hood 54. One end of the radiator 44 is attached to the radiator mounting brackets 48 of the module structure 26, and the opposing end of the radiator 44 is attached to two vertical struts 92 that each extend upwardly from one of the beams 28a and 28b of the module structure 26. A fastener (not shown) is received in an aperture 94 (shown in FIG. 3) in each of the beams 28a and 28b to attach each of the two vertical struts 92 to the module structure 26. A fastener (not shown) also attaches the radiator 44 to each of the two vertical struts 92.

The two remotely driven fans 52 are also mounted at an incline and are also generally parallel to the hood 54. That is, the slope of the hood 54 is approximately equal to the slope of the radiator 44 and approximately equal to the slope of the two remotely driven fans 52. The two remotely driven fans 52 are each attached to a shroud 96 that covers the radiator 44. By sloping the hood 54 relative to the ground, the front of the cab 12 has a substantially triangular appearance as viewed from the side of the vehicle 10. Driver visibility is improved because the hood 54 extends downwardly toward the ground rather than parallel to the ground. The aerodynamic shape of the cab 12 is also improved, and the weight of the hood 54 can be reduced.

During normal operation of the vehicle 10, there is adequate ram air to cool the liquid coolant in the radiator 44. A dual remote fan drive 99 attached to the radiator 44 activates the two remotely driven fans 52 only when the vehicle 10 is traveling at low speeds or when the vehicle 10 is traveling over an inclined surface and the temperature of the liquid coolant in the radiator 44 increases. When a temperature sensor 98 detects that the temperature of the liquid coolant in the radiator 44 is above a threshold temperature, the dual remove fan drive 99 activates the two remotely driven fans 52 to cool the liquid coolant in the radiator 44. Therefore, the power required to operate the two remotely driven fans 52 is reduced, conserving fuel. By employing two small remotely driven fans 52, rather than a large single fan, fan noise is significantly decreased and less insulation is needed.

A drive shaft 56 extending from the engine 46 transfers rotational energy from the engine 46 to the rear wheels 84 of the vehicle 10. Because the engine 46 is located under the driver's seat 14, the length of the drive shaft 56 extending to the rear wheels 84 is reduced. Therefore, the drive shaft 56 can be one piece, reducing weight and maintenance. Additionally, because the engine 46 is lowered, the pinion angle is reduced.

The module structure 26 can also include additional mounting brackets to allow other vehicle components to be attached. For example, other vehicle components such as batteries, exhaust after-treatment components, and fuel cells can be attached via such brackets. Although these vehicle components are described, it is to be understood that other components can be attached to the module structure 26. One skilled in the art would appreciate other vehicle components that can be attached in a similar manner.

The complete module structure 26 with all the components installed, including the independent front suspension 38, the engine 46, the radiator 44, and the energy-absorbing front bumper 58, can be easily installed at the OEM assembly plant by mounting the module structure 26 to the frame beams 22, the cab 12 and the hood 54, reducing the in-plant labor by the OEM.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A module attachable to a pair of frame beams of a vehicle, the module comprising:
a module structure having a front end and a rear end;
a front suspension attached to the module structure between the front end and the rear end; and
an engine mount positioned near the rear end of the module structure, wherein the engine mount is adapted to support an engine.

2. The module as recited in claim 1 wherein the module structure comprises a plurality of main beams, a plurality of first cross-beams, and a plurality of second cross-beams, wherein the plurality of main beams are attached to a pair of frame beams.

3. The module as recited in claim 2 wherein the plurality of main beams are substantially parallel to each other and are also substantially parallel to the pair of frame beams.

4. The module as recited in claim 3 wherein the plurality of first cross-beams and the plurality of second cross-beams are substantially perpendicular to the plurality of main beams with the plurality of first cross-beams also being substantially perpendicular to the plurality of second cross-beams.

5. The module as recited in claim 1 wherein the rear end of the module structure is attachable to a pair of frame beams to define a vehicle frame.

6. The module as recited in claim 1 including a suspension mount wherein the front suspension is attached to the suspension mount.

7. The module as recited in claim 1 wherein the engine is attached to the engine mount.

8. The module as recited in claim 1 including a radiator mount supported by the module structure and adapted to support a radiator, wherein the radiator is attached to the radiator mount.

9. The module as recited in claim 8 including a plurality of fans adapted to blow air over the radiator.

10. The module as recited in claim 8 wherein the radiator is mounted on the module structure such that the radiator is inclined relative to a pair of frame beams when the module structure is attached to the pair of frame beams to define a vehicle frame.

11. The module as recited in claim 8 wherein the radiator mount is positioned near the front end of the module structure, and wherein the front suspension is located between the radiator mount and the engine mount.

12. The module as recited in claim 1 wherein the front end of the module structure is attachable to a hood of a vehicle.

13. The module as recited in claim 12 including a radiator mount supported by the module structure and adapted to support a radiator, wherein the radiator is attached to the radiator mount, and the radiator is substantially parallel to the hood when the module structure is attached to a pair of frame beams to define a vehicle frame.

14. The module as recited in claim 1 wherein the front suspension comprises a stabilizer bar having a first end and a second end, a first control arm attached to the first end, and a second control arm attached to the second end, wherein the first control arm and the second control arm are each attachable to a knuckle, and a wheel is attachable to the knuckle.

15. The module as recited in claim 1 including a bumper mount supported by the module structure and adapted to support a bumper, wherein the bumper is attached to the bumper mount.

16. A vehicle comprising:
a pair of frame beams; and
a module structure attached to the pair of frame beams to define a vehicle frame, the module structure comprising:
a front end;
a rear end attached to the vehicle frame;
an engine mount positioned near the rear end;
an engine attached to the engine mount;
a radiator mount positioned near the front end;
a radiator attached to the radiator mount;
a suspension mount positioned between the engine mount and the radiator mount; and
a front suspension attached to the suspension mount.

17. The vehicle as recited in claim 16 wherein the front suspension comprises a stabilizer bar having a first end and a second end, a first control arm attached to the first end, and a second control arm attached to the second end, wherein the first control arm and the second control arm are each attached to a wheel.

18. The vehicle as recited in claim 16 wherein the module structure comprises a plurality of main beams, a plurality of first cross-beams, and a plurality of second cross-beams, wherein the plurality of main beams are attached to the pair of frame beams.

19. The vehicle as recited in claim 18 wherein the plurality of main beams are substantially parallel to each other and are also substantially parallel to the pair of frame beams.

20. The vehicle as recited in claim 19 wherein the plurality of first cross-beams and the plurality of second cross-beams are substantially perpendicular to the plurality of main beams with the plurality of first cross-beams also being substantially perpendicular to the plurality of second cross-beams.

21. A method of forming a module structure for a vehicle comprising the steps of:
attaching a front suspension to the module structure between a front end and a rear end of the module structure;
attaching an engine near the rear end of the module structure; and
attaching the module structure to a pair of frame beams to define a vehicle frame.

22. The method as recited in claim 21 further including the step of attaching a radiator near the front end of the module structure, and the steps of attaching the radiator, attaching the engine, and attaching the front suspension occur before the step of attaching the module structure to the pair of frame beams.
